(19) United States
(12) Patent Application Publication
(10) Pub. No.: US 2013/0092855 A1
(43) Pub. Date: Apr. 18, 2013

(54) CORROSION RESISTANT VALVE AND PLUNGER

(71) Applicants: Willliam Bebb, Kearney, NE (US); Randy Kline, Greeley, CO (US)

(72) Inventors: Willliam Bebb, Kearney, NE (US); Randy Kline, Greeley, CO (US)

(73) Assignee: ENVIROTECH SERVICES, INC., Greeley, CO (US)

(21) Appl. No.: 13/272,023

(22) Filed: Oct. 12, 2011

(51) Int. Cl. F16K 31/02; F16K 1/00

(52) U.S. Cl. 251/129.15; 251/318

(57) ABSTRACT

A valve for controlling flow of a liquid is provided. The solenoid valve includes a valve body, a spring, and a plunger. The valve body includes an input port, an output port, and an orifice between the input port and the output port. The spring is positioned within a cylindrical cavity of the valve body. The plunger is within the cavity and the position of the plunger in the cavity controls flow of the liquid between the input port and the output port through the orifice. The plunger includes a core and a sleeve. The sleeve is made of a non-metallic corrosion resistant material and provides mechanical interfaces for the plunger. The core is made of a ferritic material.

### TECHNICAL FIELD

Various embodiments of the present invention relate generally to valves. More specifically, some embodiments of the present invention relate to a valve with a corrosion resistant plunger.

### BACKGROUND

Valves are used to control the flow of liquids and gases in a wide variety of industrial and commercial processes. Because many of these processes are automated, remotely actuated valves are commonly used. One of the most common types of automated valves is the electrically actuated solenoid valve. A solenoid valve has two main parts: the solenoid and the valve. The solenoid converts an electrical signal into mechanical energy which, in turn, exerts a mechanical force to open or close the valve.

The typical direct acting solenoid valve contains a valve body with at least one input port and one output port connected through an orifice. The valve body makes up the flow path of the gas or liquid. A movable plunger is used to, alternately, block the orifice, or permit flow of the gas or liquid through the orifice. Direct acting solenoid valves with multiple input ports, multiple output ports, and/or multiple orifices are common and operate in similar manners. The plunger is typically made of a magnetic material and moved using electromechanical, mechanical, and fluidic forces. In many cases, a mechanical spring is used to force the plunger into one position when the valve is not energized. When the valve is energized, a current flows through a coil exerting an electromagnetic force on the plunger. A sufficiently large electromagnetic force will overcome the force of the mechanical spring, and other forces, and move the plunger from its default position, thereby switching the valve to a different location thereby placing the valve in the opposite state. Other components including valve seats, seals, diaphragms, and gaskets are also common. Valves are often designed to also take advantage of the forces of the liquid or gas being controlled.

Because valves commonly use a number of different metallic components, corrosion of the components is a common problem. Corrosion may occur for several reasons. In some cases, a valve may be used to control a corrosive liquid or gas and corrosion may occur due to the interaction between the liquid or gas and any of the individual components of the valve. In other cases, galvanic corrosion may occur when different metallic components of the valve are in contact with each other. This galvanic corrosion process is often accelerated when the metallic components are exposed to the liquid being controlled and the liquid acts as an electrolyte. Other types of corrosion are also possible.

### SUMMARY

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

In some embodiments, a valve for controlling flow of a liquid is provided. The valve includes a valve body, a spring, and a plunger. The valve body includes an input port, an output port, and an orifice between the input port and the output port. The spring is positioned within a cylindrical cavity of the valve body. The plunger is within the cavity and the position of the plunger in the cavity controls flow of the liquid between the input port and the output port through the orifice. The plunger includes a core and a sleeve. The sleeve is made of a non-metallic corrosion resistant material and provides mechanical interfaces for the plunger. The core is made of a magnetic material.

In some embodiments, the magnetic material is 400 series stainless steel.

In some embodiments, the non-metallic corrosion resistant material is an acetal resin.

In some embodiments, the non-metallic corrosion resistant material is Delrin.

In some embodiments, the valve includes an electrical coil which, when energized, exerts an electromagnetic force on the core and moves the plunger.

In some embodiments, the sleeve is cylindrical, includes a recess, and the core is inserted in the recess.

In some embodiments, the sleeve contains one or more channels extending the length of the sleeve. The one or more channels allow the liquid to flow from one end of the sleeve to another end of the sleeve while the sleeve is inserted in the cylindrical cavity of the valve body.

In some embodiments, a plunger for controlling flow of a liquid through a valve is provided. The plunger includes a plunger shell and a plunger core. The plunger shell is made of a non-metallic corrosion resistant material and provides the mechanical interfaces between the plunger and other components of the valve. The plunger core is attached to the plunger shell and is made of a ferritic material.

### BRIEF DESCRIPTION OF THE DRAWINGS

Embodiments of the present invention will be described and explained through the use of the accompanying drawings.

FIG. 1 illustrates an example of a solenoid valve.

FIG. 2 illustrates an example of a plunger for a solenoid valve.

FIG. 3 illustrates an example of a plunger for a solenoid valve.

FIG. 4 illustrates an example of a valve plunger with a relief channel.

FIG. 5 illustrates an example of a valve plunger with a relief channel.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments of the present invention relate generally to valves. More specifically, some embodiments of the present invention relate to a valve with a corrosion resistant plunger.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Solenoid valves are commonly used to control flow of liquids and gasses. Direct acting solenoid valves commonly comprise a valve body, plunger, and spring. The plunger and spring are commonly inside a cavity and move within the valve body to control flow of the liquid or gas through the valve body. The spring and plunger, along with other components of the valve, are commonly made of metallic materials. The plunger, in particular, typically has magnetic or ferritic properties in order to respond to electromagnetic forces exerted by an electrical coil.

In many designs, the plunger and spring, as well as some of the other components, are immersed in the liquid or gas. These components are subject to the corrosive properties of the liquid or gas. Even if the components are each made of metallic materials, like stainless steel, which are less susceptible to corrosion from the liquid or gas, they are still subject to galvanic corrosion. Galvanic corrosion is an electrochemical process which occurs when dissimilar metals or alloys are in contact with each other and immersed in an electrolyte. Pairs of metals can be chosen to minimize the galvanic effect but the optimization of galvanic pairs is also dependent on the electrolyte. As a result, relying on galvanic pairing alone will result in a valve which may work well over time with some liquids but not with others.

For the reasons described above, it is preferential to design a valve which has components with the necessary metallic qualities, but minimizes contact between metallic components. Particularly, the components which are also in contact with the liquid being controlled. The plunger is often the most problematic component in many valves because it immersed in the liquid, comes into contact with several components of the valve, must have magnetic characteristics, is movable, and directly implements the primary function of the valve. These problems are particularly pronounced when the liquid being used is a corrosive liquid.

In one example, various salt solutions used for anti-icing and de-icing of roads have proved problematic over time when used with solenoid valves of this type. This is true because salt solutions often exacerbate galvanic processes. Due to the nature of the use, the concentrations, purity, and other characteristics of these solutions may not be as tightly controlled as they might be in a manufacturing or food processing application. In addition, large environmental variations may further contribute to corrosion problems in road treatment applications. However, corrosion problems can occur in many applications involving many different types of gases and liquids, including water.

The present invention provides a valve with an improved plunger. The plunger is comprised of components to minimize or eliminate the problems described above.

Although many of the examples of the present invention provided herein are described with respect to a solenoid valve, these examples are in no way meant to be limiting. One skilled in the art will understand that the invention may be applied to valves of other types. The invention is intended to cover all implementations falling within the scope of the invention as defined by the appended claims. In the following descriptions, for the purposes of explanation, numerous specific details are set forth in order to provide a thorough understanding of the embodiments of the present invention. It will be apparent, however, to one skilled in the art that embodiments of the present invention may be practiced without some of these specific details.

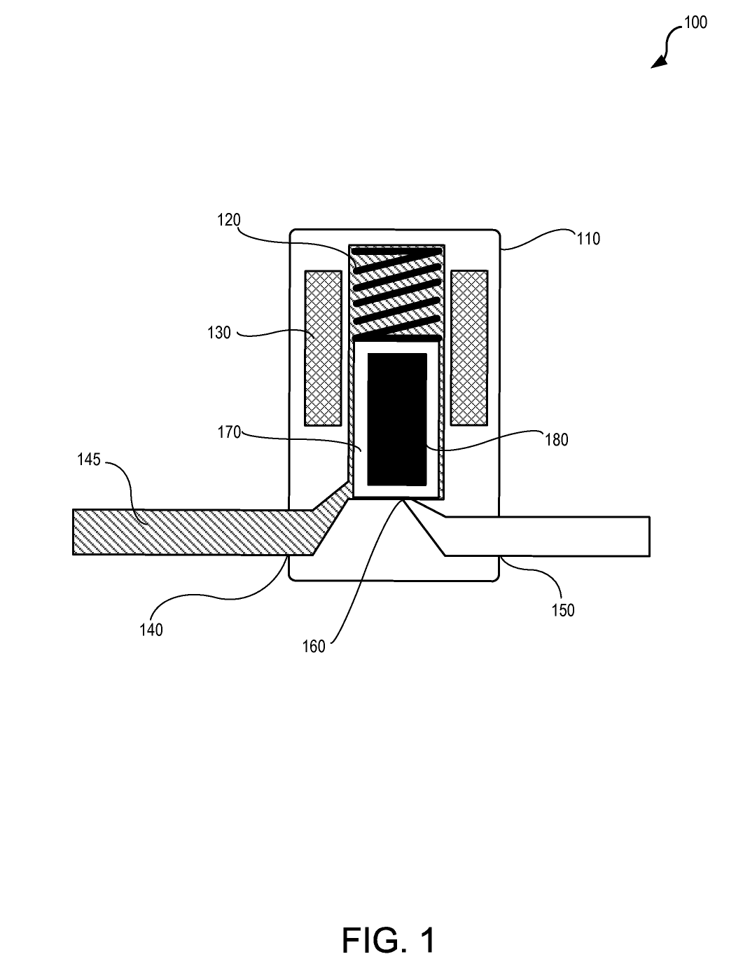

Having described embodiments of the present invention generally, attention is directed to FIG. 1 which illustrates a cross section of solenoid valve 100. Solenoid valve 100 is one exemplary implementation of the present invention.

Solenoid valve 100 comprises valve body 110, spring 120, coil 130, input port 140, outlet port 150, orifice 160, plunger sleeve 170, and plunger core 180. Solenoid valve 100 may be used to control flow of liquid 145 from input port 140 to output port 150. Liquid 145 flows into input port 140 through piping of some type and fills the cavity in valve body 110 which contains spring 120 and the plunger components. The flow of liquid 145 through orifice 160 and out outlet port 150 is controlled by the location of plunger sleeve 170. If plunger sleeve 170 is blocking orifice 160, liquid 145 cannot reach orifice 160 and will not flow.

The interface between plunger sleeve 170 and orifice 160 is typically more complex than illustrated and may include other components including seals, seats, gaskets, diaphragms, and/or a more complex structure. These additional components and structures are often necessary to provide a reliable, durable seal which operates properly under a wide variety of conditions. The detailed design elements of this sealing interface are not illustrated or discussed in detail as they are ancillary to the improvements provided by this invention. However, they may be useful in the operation or use of the invention.

Solenoid valve 100 is a normally closed valve. The non-energized state of the valve is a closed position. If no energy is applied to the valve, plunger sleeve 170 blocks orifice 160 and liquid 145 is not allowed to flow through valve body 110. This is because spring 120 is inserted into the cavity of valve body 110 in a compressed state along with valve sleeve 170. Because it is confined, spring 120 exerts a force on plunger sleeve 170 moving plunger sleeve 170 to the end of the cavity and blocking orifice 160. Valve body 110 is illustrated as a single component but is typically comprised of multiple assembled components and may include gaskets or seals to create a pressure tight enclosure. Although not necessary, valve body 110 is commonly composed of a metallic material for purposes of durability, strength, and corrosion resistance.

In order to open solenoid valve 100 and allow liquid 145 to flow through output port 150, a force must be exerted on plunger sleeve 170 causing it to move away from orifice 160. In the case of solenoid valve 100, this force is created by coil 130. Coil 130 is an insulated electrical conductor with multiple turns. Coil 130 is oriented such that an electrical current flowing through it results in an electromagnetic field which exerts a force on ferritic or magnetic objects in or near the coil. The electromagnetic force pushes these objects in a direction away from orifice 160. Aside from the force of spring 120, plunger sleeve 170 is relatively free to move within the cavity of valve body 110. If valve sleeve 170 contains magnetic properties, or is attached to an object with magnetic properties, plunger sleeve 170 will be subject to this force. If the force is strong enough to overcome the force of spring 120, and any other forces caused by liquid 145, plunger sleeve 170 will move away from orifice 160. The valve will then be open and liquid 145 will flow from input port 140 to output port 150. This situation will continue until current is removed from coil 130.

If plunger sleeve 170 is made of a magnetic metallic material, the solenoid valve will operate as described above. However, this configuration may present some problems because plunger sleeve 170 is in contact, or has mechanical interfaces, with other components which are also preferably made of metallic materials. These other components may include spring 120, valve body 110, other components in the cavity of valve body 110, or other components associated with orifice 160 and the seating surfaces.

Manufacturing plunger sleeve 170 from a non-metallic corrosion resistant material will eliminate these metal-to-metal contact points and significantly decrease the likelihood of failure or contamination of solenoid valve 100 due to corrosion. However, plunger core 180, made of a magnetic material, must be attached to or inserted in plunger sleeve 170 in order for plunger sleeve 170 to remain responsive to the electromagnetic forces produced by coil 130. Plunger core 180 is attached to or inserted into plunger sleeve 170 to serve this function. Plunger core 180 is attached to plunger sleeve 170 in a permanent manner such that they will move together.

In the combined assembly, plunger core 180 provides the necessary magnetic properties while plunger sleeve 170 contacts other components of the valve. Plunger core 180 may be completely contained with plunger sleeve 170 or may simply be attached in a manner such that it does not come into contact with other metallic components.

Plunger sleeve 170 may be made from one or more of many possible non-metallic corrosion resistant materials. Acetal resins, polyoxymethylene, and Delrin® are good candidates as they have good corrosion resistance to many chemicals, low liquid absorption, high abrasion resistance, high heat resistance, good dielectric properties, good stiffness, good dimensional stability, and a low coefficient of friction. When made of a material of this nature, plunger sleeve 170 experiences significantly less corrosion, particularly at points of contact with spring 120, valve body 110, or other metallic components.

The improvements described herein are equally applicable to a normally open solenoid valve, two-way valves, three-way valves, four-way valves, internally piloted solenoid valves, as well as other types of valves which use a plunger.

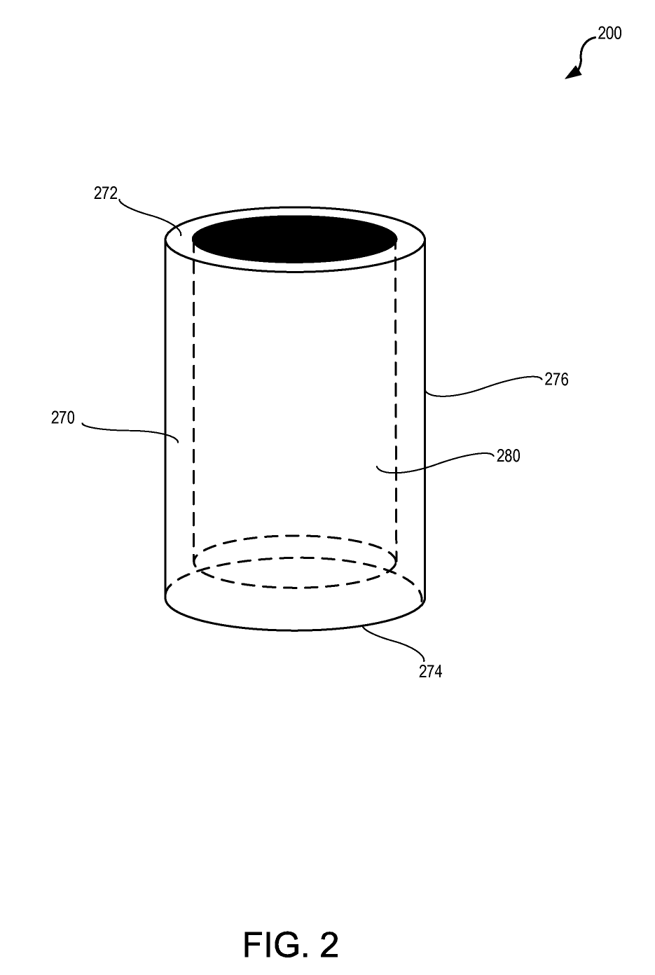

FIG. 2 illustrates plunger 200 for a solenoid valve. Plunger 200 is comprised of plunger sleeve 270 and plunger core 280. Plunger sleeve 270 and plunger core 280 are examples of plunger sleeve 170 and plunger core 180 of FIG. 1, respectively, although other configurations and designs are possible. Plunger sleeve 270 is made of a non-metallic corrosion resistant material. Plunger core 280 is made of a magnetic or ferritic material such that plunger 200, the combined assembly, will respond to electromagnetic forces.

Plunger core 280 may be attached to plunger sleeve 270 in a number of ways. Plunger core 280 may be pressed, threaded, glued, or snapped into plunger sleeve 270, or attached in other ways, including using fasteners. While plunger core 280 is illustrated as a cylindrically shaped object inserted into a cylindrically shaped recess in plunger sleeve 270, the shape of plunger core 280 and the recess are relatively unimportant. The volume of plunger core 280 and its positioning relative to the surfaces of plunger sleeve 280 are the important design elements. Plunger 280 must have a sufficient volume of a material with magnetic properties such that the electromagnetic force overcomes the force of a spring and/or other forces in the valve. If plunger core 280 is too small, not enough mechanical force will be generated.

It is also important that plunger sleeve 270 provide the mating surfaces, or mechanical interfaces, where plunger 200 comes into contact with other components of the valve. For example, spring seating surface 272, seating surface 274, and wall 276 are likely to come into contact with other components of a valve assembly when inserted into a cylindrical cavity of the valve assembly.

One circular surface of plunger core 280 is illustrated as being flush with spring seating surface 272. Flushness is not important as long as plunger core 280 will not contact the spring. Plunger core 280 could extend beyond spring seating surface 272 or could be recessed within plunger sleeve 270. Since one surface of plunger core 280 is exposed to the liquid or gas in the valve cavity, it will still need to be made of a non-corrosive material for many applications. The 400 series of stainless steels (410, 410S, 416, 420, 430, 440C, etc.) are commonly used in these types of applications. Despite being categorized as stainless steels, they have magnetic properties. The 400 series stainless alloys have chromium as their major alloying element and are typically low in carbon content. While usually not as durable or corrosion resistant as the 300 series of stainless steels, they are more durable and corrosion resistant than carbon steel and many other ferritic materials.

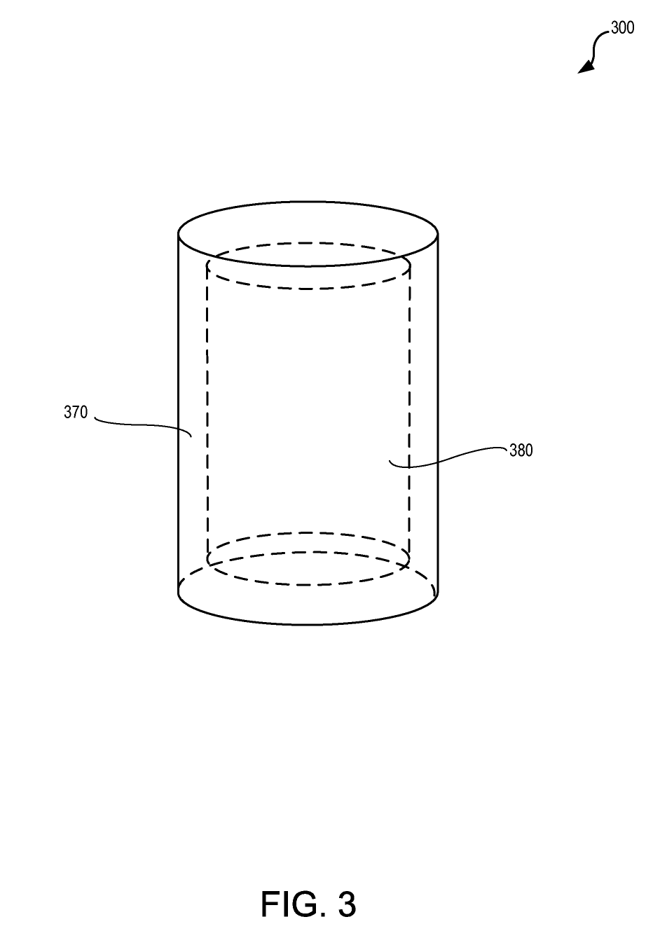

FIG. 3 illustrates plunger 300 for a solenoid valve. Plunger 300 is a variation of plunger 200 in which plunger core 380 is fully encased in plunger sleeve 370. Plunger core 380 serves only a magnetic purpose so it is acceptable that it has no external surface exposure on plunger 300. One benefit to this design is that plunger core 380 no longer necessarily needs to be manufactured of a non-corrosive material as it has no exposure other than to the non-corrosive non-metallic material of plunger sleeve 370. As with plunger core 280, the shape of plunger core 380 is unimportant. Plunger core 380 could be a rectangular block of material, or any other shape.

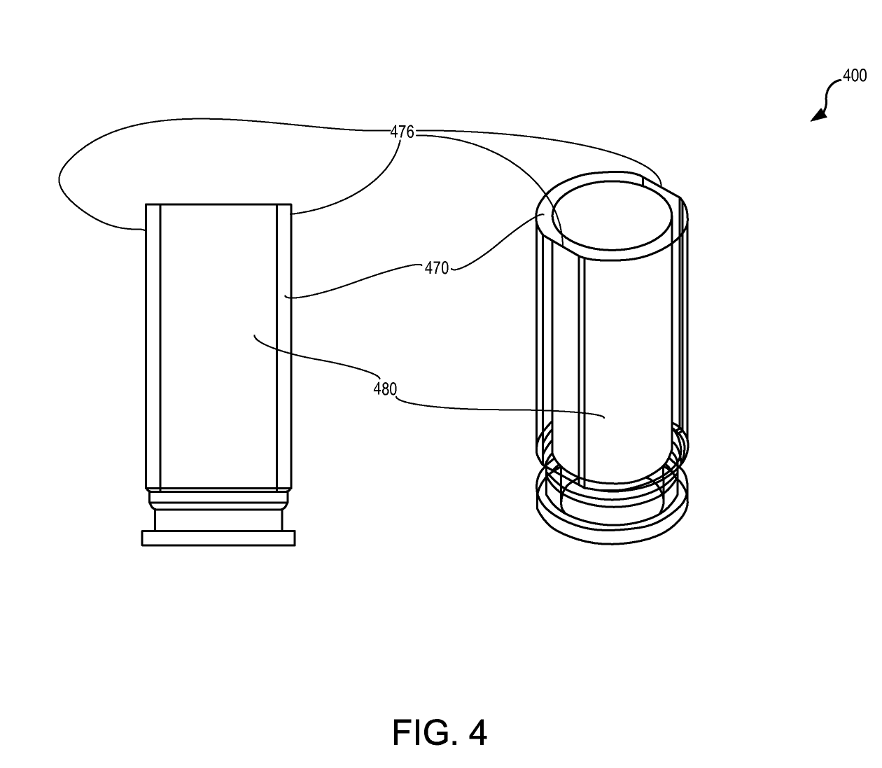

FIG. 4 illustrates two views of plunger 400 for a solenoid valve. Plunger 400 is similar to plunger 200 and plunger 300 in that a plunger core is inserted into a plunger sleeve. Like previous examples, plunger core 480 is made of a ferritic or magnetic material and inserted into plunger sleeve 480 which is made of a non-corrosive non-metallic material. Plunger core 470 could also be fully encased or sealed inside plunger sleeve 480, as in plunger 300.

Plunger 400 differs from the previously described embodiments in that the external surface of plunger sleeve 470 contains channels extending the length of the sleeve. It is desirable that the diameter of the valve cavity in which plunger 400 is inserted is only slightly larger than the diameter of plunger 400. This relationship is desirable in order to insure minimal deviation or variation in the alignment of plunger 400 in the cavity. In other words, minimizing non-axial movement of the plunger in the cavity. However, since the entire cavity may be filled with liquid or gas, the liquid or gas must be able to flow from one end of plunger 400 to the other end of plunger 400 within the valve cavity in order for plunger 400 to move relatively freely within the cavity without creating pressures or vacuums.

Channels 476 are longitudinal passageways which allow the liquid or gas to move more freely from one end of plunger 400 to the other while plunger 400 resides in a cylindrical cavity which is only slightly larger in diameter than plunger 400. Channels 476 are illustrated as flats on opposing sides of plunger 400. However, it should be understood that the number, shape, size, and location of the channels can vary as long as they are sufficiently large to allow the liquid or gas to flow from one end of plunger 400 to the other.

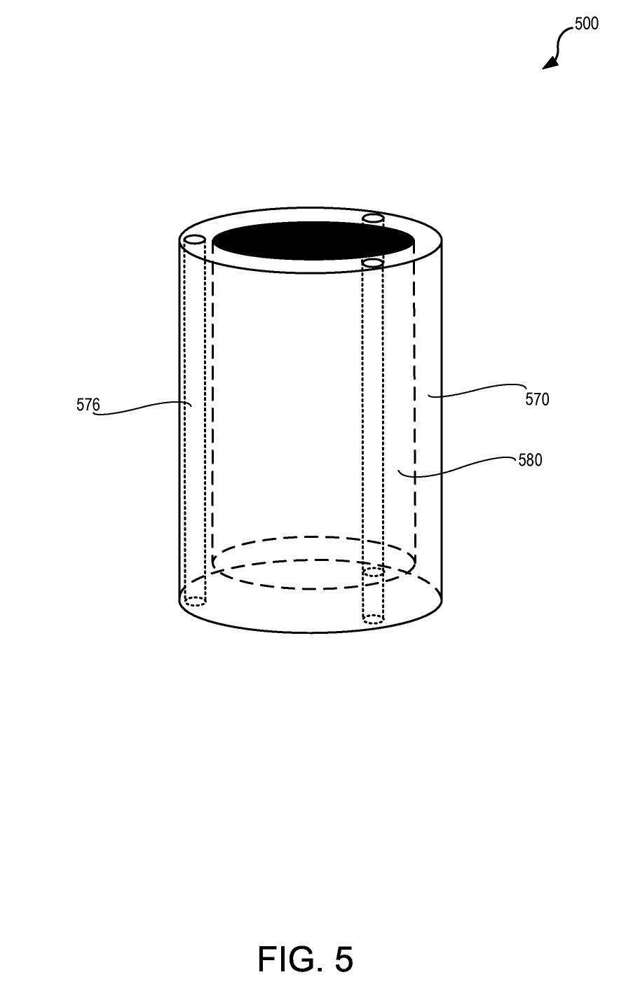

FIG. 5 illustrates plunger 500 for a solenoid valve. Plunger 500 is a variation of plunger 400 in which channel 576 extends inside plunger sleeve 570 rather than on the surface of the plunger sleeve. As with plunger 400, the channel allows liquid or gas to travel from one end of plunger 500 to the other when it is sliding within a cavity which is only slightly larger in diameter than the plunger itself. Three channels are illustrated in plunger 500 although fewer or more are possible. In addition, many variations in the shape, size, and location of channel 576 are possible. In some examples, channel 576 could extend through plunger core 580 in addition to portions of plunger sleeve 570. In other examples, one or more channels could be implemented using features of external channels 476 and internal channel 576.

Terminology:

The phrases “in some embodiments,” “according to some embodiments,” “in the embodiments shown,” “in other embodiments,” “in some examples,” “in other examples,” and the like generally mean the particular feature, structure, or characteristic following the phrase is included in at least one embodiment of the present invention, and may be included in more than one embodiment of the present invention. In addition, such phrases do not necessarily refer to the same embodiments or different embodiments.

If the specification states a component or feature “may”, “can”, “could”, or “might” be included or have a characteristic, that particular component or feature is not required to be included or have the characteristic.

While, for convenience, embodiments of the present invention are described with reference to a direct acting solenoid valve, embodiments of the present invention are equally applicable to other types of valves.

In conclusion, the present invention provides a novel valve and plunger for a valve. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

What is claimed is:

1. A valve for controlling flow of a liquid comprising:
a valve body comprising an input port, an output port, and an orifice between the input port and the output port;
a spring positioned within a cylindrical cavity of the valve body;
a plunger within the cavity, wherein a position of the plunger in the cavity controls flow of the liquid between the input port and the output port through the orifice, the plunger comprising a core and a sleeve, the sleeve being made of a non-metallic corrosion resistant material and providing mechanical interfaces of the plunger, the core being made of a ferritic material.

2. The valve of claim 1 wherein the ferritic material comprises 400 series stainless steel.

3. The valve of claim 1 wherein the non-metallic corrosion resistant material is an acetal resin.

4. The valve of claim 1 further comprising an electrical coil which, when energized, exerts an electromagnetic force on the core thereby moving the plunger.

5. The valve of claim 1 wherein the sleeve is cylindrical in shape and comprises a recess, the core inserted in the recess.

6. The valve of claim 5 wherein a surface of the sleeve contains one or more channels extending the length of the sleeve, the one or more channels allowing the liquid to flow from one end of the sleeve to another end of the sleeve while the sleeve is inserted in the cylindrical cavity of the valve body.

7. A solenoid valve assembly for controlling flow of a liquid comprising:
a valve body comprising at least two liquid ports and an orifice between the at least two ports;
an electrical coil;
a plunger movable within a cavity of the valve body, the plunger being made of a non-metallic corrosion resistant material wherein a position of the plunger controls flow of the liquid between the ports;
a plunger core attached to the plunger such that the plunger core cannot contact other components of the valve assembly, the plunger core being made of a magnetic material responsive to electromagnetic forces of the electrical coil.

8. The solenoid valve assembly of claim 7 wherein the non-metallic corrosion resistant material is polyoxymethylene.

9. The solenoid valve assembly of claim 7 wherein the magnetic material comprises 400 series stainless steel.

10. The solenoid valve assembly of claim 7 wherein the cavity and the plunger are cylindrical in shape and the plunger slides in the cavity along an axis of the plunger.

11. The solenoid valve assembly of claim 10 further comprising a spring in the cavity, the spring positioned to exert force on the plunger without contacting the plunger core.

12. A plunger for controlling flow of a liquid through a valve comprising:
a plunger shell made of a non-metallic corrosion resistant material wherein the plunger shell provides mechanical interfaces between the plunger and components of the valve; and
a plunger core attached to the plunger shell, the plunger core comprising a ferritic material.

13. The plunger of claim 12 wherein the ferritic material comprises 400 series stainless steel.

14. The plunger of claim 12 wherein the non-metallic corrosion resistant material is an acetal resin.

15. The plunger of claim 12 wherein the plunger is cylindrically shaped and slides in a cylindrically shaped cavity of the valve.

16. The plunger of claim 15 further comprising one or more axial channels allowing the liquid to flow from one end of the plunger to another end of the plunger while the plunger is inserted in the cavity.

17. A plunger assembly slidably disposed in an internal passage of a valve assembly for controlling flow of a liquid through the internal passage, the plunger assembly comprising:
a cylindrically shaped plunger shell made of a non-metallic corrosion resistant material; and
a plunger core contained, at least partially, within the plunger shell such that the plunger core cannot contact components of the valve assembly, the plunger core comprising a metallic material responsive to electromagnetic forces of an electrical coil of the valve assembly.

18. The plunger assembly of claim 17 wherein the non-metallic corrosion resistant material is Delrin.

19. The plunger assembly of claim 17 wherein the metallic material is 400 series stainless steel.

20. The plunger assembly of claim 17 wherein the internal passage is cylindrical and the plunger assembly further comprising one or more channels allowing the liquid to flow from one end of the plunger assembly to another end of the plunger assembly while inserted in the internal passage of the valve assembly.
